(19) United States
(12) Patent Application Publication
(10) Pub. No.: US 2004/0143491 A1
(43) Pub. Date: Jul. 22, 2004

(54) Method and system for management of purchasing incentives

(76) Inventor: Marty Steinberg, Coral Gables, FL (US)

Correspondence Address: Nancy J. Flint, Hunton & Williams, 1111 Brickell Avenue, Miami, FL, 33131, US

(21) Appl. No.: 09/921,060

(22) Filed: Aug. 2, 2001

(51) Int. Cl. G06F 17/60

(52) U.S. Cl. 705/14

(57) ABSTRACT

A management system and method that enables consumers to determine the availability of purchasing incentives through their memberships in loyalty programs is disclosed. Consumers may maintain their memberships to various loyalty programs of companies and organizations that offer purchasing incentives in a secured interactive database, and can submit a query about available purchasing incentives for the potential purchase of a product, based on these memberships. The management system processes the query, retrieves available incentives from at least one offering company or organization registered with the management system, and communicates the available incentives to the consumer who submitted the query. Promotion compensation may be offered to consumers whether or not they are offered a purchasing incentive. In addition, consumers may be offered links or information to purchase the desired product or service directly from the management system, or may be provided vendor or manufacturer information for the desired product or service.

### FIELD OF THE INVENTION

The invention relates generally to management of and access to purchasing incentives offered through loyalty programs of companies and organizations. More particularly, it relates to a method and system that allows consumers to effectively manage and readily access the various purchasing incentives offered through their memberships in the loyalty programs of companies and organizations.

### BACKGROUND OF THE INVENTION

Many companies and organizations offer their customers and/or members a wide array of discounts, rebates, coupons, awards, prizes, extended warranties, insurance, and other purchasing incentives through so-called “loyalty programs.” These programs may range in complexity from a simple punch-card where a repeat customer receives a free item after purchasing some predetermined number of items, to multi-partner syndicated retail loyalty programs. Points in loyalty programs can carry a great deal of value to the holder, and may even be donated as charitable items as, for example, donations of frequent flyer program miles to organizations as the Make-A-Wish Foundation™. Often these purchasing incentive offers have purchase or use requirements that must be satisfied for the consumer to realize the reward. For example, a consumer may be entitled to a reduced hotel room rate if the room charge is paid for using the offering company's credit card, and if the consumer stays at the designated hotel during certain time periods. The main objective of offering these loyalty programs is to increase customer retention and loyalty to the company or organization, while providing the offering company or organization marketing data on their consumer base.

However, consumers are inundated with such a wide variety of purchasing incentive offers from credit card companies, travel services companies, membership organizations, and other companies that the incentives are practically unusable due to the simple fact that consumers are not aware of, cannot effectively manage, are unfamiliar with the details associated with, or do not have immediate access to purchasing incentives offered through loyalty programs. As a result, many consumers do not take advantage of the purchasing incentives that are offered to them, and offering companies and organizations do not develop the marketing data that they desire.

### DESCRIPTION OF RELATED ART

Systems and methods for offering purchasing incentives to consumers are well known in the art. Typically, these systems involve the registration of a consumer with a central host, where the consumer provides certain marketing data as demographics, income, age, marital and family status, family description, and buying preferences. Companies and organizations also register with the central host, and offer targeted consumers coupons and other purchasing incentives to purchase their products or services. In addition, the offering companies and organizations are provided with the marketing data of the registered consumers.

For example, U.S. Pat. No. 5,761,648 issued to Golden et. al., the disclosure of which is herein incorporated by reference and in a manner consistent with the invention, relates to a system for registered companies to offer electronic certificates to registered consumers, for registered consumers to receive and print out those certificates, and for the registered companies to receive marketing data on the registered consumers. U.S. Pat. Nos. 5,970,469 and 6,014,634 issued to Scroggie et. al. disclose systems for consumers to select purchasing incentives offered by various retailers, and for the incentives to be delivered either to the consumer or directly to retail stores.

The systems disclosed in U.S. Pat. Nos. 5,774,870 and 6,009,412, issued to Storey, the disclosures of which are herein incorporated by reference and in a manner consistent with the invention, relate to the offer of products for sale, and the award of bonus points for the purchase of the products to consumers who may redeem the bonus points for an award selected from an award catalog.

U.S. Pat. No. 6,195,644 issued to Bowie relates to a system for the recording of credits in loyalty programs by credit card companies. The credit card company tracks purchases of third company products made by its credit card holders that result in bonus points awarded to that credit card holder by the third company, relieving the third company of the burden of maintaining these records.

Using known systems, consumers can select purchasing incentives offered by companies for those companies' products. In addition, companies can selectively offer purchasing incentives for their products to consumers based on marketing data disclosed to the host systems. Thus, present systems revolve around the creation, selection, and targeting of purchasing incentives for specific products and services, based on either a desire to purchase that product or service by the consumer, or a desire to sell a product or service by a company. These systems, however, do not address the problem of underutilization of existing purchasing incentives that consumers are entitled to based on their present memberships in loyalty programs or the management of or lack of immediate access to such incentives.

In contrast, the invention relates to the management of and immediate access to presently existing purchasing incentives to allow the consumer to more efficiently and effectively utilize these incentives, and to provide those companies and organizations offering these loyalty programs the marketing data that they desire.

### SUMMARY OF THE INVENTION

The invention provides a new management system and method that facilitates consumers' knowledge of, management of, and access to the various purchasing incentives offered to them through their memberships in loyalty programs. In addition, the invention provides the offering companies and organizations desired marketing data on their consumer base because more consumers will take advantage of the purchasing incentives by using the system and method.

It is, thus, an object of the invention to provide a convenient, fast, and economical method and system for managing purchasing incentives offered to consumers due to their membership in various loyalty programs.

It is another object of the invention to provide a method and system for making purchasing incentives or rewards, i.e., incentives offered to consumers by offering companies organizations for the purchase or use of their products or services, readily available to consumers.

It is yet another object of the invention to provide a method and system for providing a consumer with a list of purchasing incentives offered to a consumer by offering companies and organizations for the purchase or use of a product or service based on the consumer's membership profile in various loyalty programs.

It is yet another objective of the invention to provide immediate information to a consumer at the point-of-sale of a product or service concerning purchasing incentives available for the desired purchase.

It is yet another object of the inventions to provide a method and system for providing marketing data on consumers to companies and organizations that offer purchasing incentives to those consumers through loyalty programs.

It is yet another object of the invention to provide a method and system for providing marketing data on consumers who participate in multiple loyalty programs to offering companies and organizations who participate in the system and method.

In one illustrative embodiment of the invention, the management system can be located on an interactive Internet web site. Consumers preferably register their various memberships in loyalty programs with the management system, which maintains this information in a secured interactive database. Companies and organizations that offer loyalty programs preferably register the purchasing incentives offered through their programs, along with the rules and conditions of those purchasing incentives, with the management system, which may also be maintained in a secured interactive database. These rules and conditions may include any conditions and restrictions on the availability of purchasing incentives, and can be personalized according to the specific consumer. Consumers can submit queries about available purchasing incentives for the potential purchase of a product or service, based on their registered memberships. The management system preferably processes the query, retrieves available incentives from the database of at least one offering company or organization registered with the management system for the purchase of the specified product or service, and communicates the available incentives to the consumer who submitted the query. Alternatively, the management system may supply consumers with a listing of the available purchasing incentives for those loyalty programs for which the consumers are members, and permit the consumers to ascertain for themselves whether any available purchasing incentives may be used on their desired product or service purchase.

Processing of the query may include the evaluation of the query according to the rules and conditions registered with the management system by the offering companies and organizations, and may also entail providing either the offering companies and organizations whose incentives satisfy the query, or all registered offering companies and organization, marketing data on consumers and queries. The submission of marketing data is preferably anonymous on the part of the consumer. Finally, the invention can offer the consumer direct links to purchase the desired product or service, or can provide the consumer with contact information for manufacturers or vendors who sell the desired product or service.

In other embodiments, the consumer may register with the management system but may not submit loyalty program information, but instead may search the management system database of registered offering companies and organizations for incentives offered for the purchase of a product or service. Offering companies and organizations may register, and have the queries submitted directly for them to determine if incentives are available under their loyalty program for the purchase of the product or service.

As used herein, the following terms mean:

Purchasing Incentives Query (“PIQ”)—A query containing one or more conditions submitted by a consumer, or an agent acting on behalf of a consumer, requesting incentives available to that consumer for the purchase or use of a product or service.

PIQ Management System—One or more data processing systems that are capable of storing consumer and offering company and organization loyalty program information, and receiving and processing PIQs on behalf of consumers for products or services that may also determine available incentives for a given PIQ. The PIQ Management System also compiles and reports the available incentives to the querying consumer, and provides marketing data to offering companies and organizations.

Offering Company or Organization−Company or organization that offers purchasing incentives to consumers based on membership in loyalty programs.

Loyalty Programs−Programs sponsored by or operated on behalf of a company or organization that offer purchasing incentives to consumers who are members of the loyalty programs for the purchase of products and services. Loyalty programs may be limited in participation and scope to certain consumers, and may also place restrictions on the award of the purchasing incentives for the purchase of products and services during specified time periods or otherwise.

### BRIEF DESCRIPTION OF THE DRAWINGS

The invention will be described with reference to the accompanying drawings, in which like elements are referenced with like numerals.

FIG. 1 is a block diagram illustrating a PIQ Management System in accordance with the invention;

FIG. 2 is a block diagram of the exemplary data processors, servers, and databases 200 of FIG. 1;

FIG. 3 illustrates a diagram of the offering company and organization database 300 of FIG. 2;

FIG. 4 illustrates a diagram of the consumer database 400 of FIG. 2;

FIG. 5 illustrates a diagram of the PIQ database 500 of FIG. 2;

FIG. 6 illustrates a diagram of the offering company and organization loyalty program rules and conditions database 600 of FIG. 2;

FIG. 7 illustrates a diagram of the promotion compensation database 700 of FIG. 2;

FIG. 8 illustrates a diagram of the PIQ history database 800 of FIG. 2;

FIG. 9 is a flow chart describing an exemplary PIQ and promotion compensation evaluation process implemented by the data processors 220 and 1000 of FIG. 2;

FIG. 10 is a flow chart describing an exemplary rules evaluation subroutine implemented by the data processor 1000 of FIG. 2;

FIG. 11 is a flow chart describing the enrollment process of a consumer; and

FIG. 12 is a flow chart describing the enrollment process of an offering company or organization.

### DETAILED DESCRIPTION OF THE INVENTION

The invention is directed to a method and system for allowing a consumer to readily identify purchasing incentives that are available to the consumer for the purchase or use of a product or service based on the consumer's memberships in the loyalty programs offered by companies and organizations. The method and system of the invention benefits consumers, helps offering companies and organizations build customer loyalty, and also provides offering companies and organizations with marketing data on their consumer bases.

The invention preferably consists of a host data processor which houses and operates the PIQ Management System that is connected by known or later developed telecommunications links to one or more consumer computers and offering companies and organizations computers. In one embodiment of the invention, the system is conducted over the Internet via any known or later developed direct or remote link, although the invention could be conducted over an intranet, from an ATM, from a dedicated terminal connected to the host data processor, or over conventional telephone systems using either a toll free 800 number or a pay to dial number. Alternatively, aspects of the invention could be conducted in stand alone systems, through the use of software programs, with communications with the host computer conducted over conventional telephone lines via modem.

In the preferred embodiment, the PIQ Management System host processor and the consumer and offering companies and organizations computers communicate over the Internet via a direct Internet connection, a dial-up Internet connection, a dial-in server access, a T1 or T3 digital line, an ISDN digital line, a LAN connection, a wide area network, an Ethernet connection, a DSL connection or any other wired or wireless connection now known or later developed. The PIQ Management System data processor preferably includes a server computer. The consumer and offering companies and organizations computers may operate commercially known web browsers, such as Microsoft Explorer® or Netscape Navigator®. Information between the consumer and offering companies and organizations web browsers and the PIQ Management System server computer may be transferred over the Internet according to any of several known Internet protocols, including HTTP and FTP.

An operating system can be installed on the PIQ Management System server computer that allows the PIQ Management System to control various applications, including data management, retrieval, and storage, web browser, and communications. Data may be stored in conventional databases, such as Oracle®. The server computer may be programmed, using known techniques, to conduct the PIQ Management System. The server computer, as well as the consumer and offering companies and organizations computers, may also contain such standard devices as RAM, ROM, hard drive, I/O devices, graphical displays, printers, and communications devices as modems.

In the preferred embodiment, companies and organizations that offer purchasing incentives to their members through loyalty programs can register for a fee with the PIQ Management System by providing information on the loyalty programs, including information on the members of the loyalty program and rules and conditions of the loyalty program which may include parameters as to what purchasing incentives are offered for what products or services, any restrictions or qualifications on the purchase of products or services for member consumers to be eligible for the purchasing incentive, any time/date restrictions, or other predefined eligibility criteria. This information is stored in the rules database, which database is secured and searchable by known techniques and techniques later developed.

Similarly, consumers may register with the PIQ Management System by providing information on the various loyalty programs to which they belong. In addition, consumers preferably will provide marketing data including demographic data, age, financial data, marital and family status, and buying preferences. This information can be stored in the consumer database, and is secured and searchable. The consumer may be assigned or can select a registration number/name and/or password for future identification to the PIQ Management System, and can be granted access to the PIQ Management System upon input of this registration number/name and/or password according to known authorization techniques.

When a registered consumer wishes to use the PIQ Management System to determine if a purchasing incentive is offered for a potential purchase of a product or service, the consumer may contact the PIQ Management System using the web browser residing on his or her computer. Alternatively, the consumer may contact the PIQ Management System over conventional telephone lines via a toll free 800 number or a pay to dial number, wherein the PIQ Management System processor may be accessed via well-known Interactive Voice Response (“IVR”) techniques coupled with well-known CTI techniques. The connection may be secured, if desired, using known protocols as Secure Sockets Layer (SSL). The consumer preferably inputs search parameters on the desired purchase, including product or service description and, if applicable, dates of use or purchase to create a PIQ. This information may be stored in the PIQ database, which is secure and searchable by known techniques and techniques later developed.

The PIQ Management System host computer may access the PIQ database, and search the rules and conditions databases of those loyalty programs that the consumer belongs to for any purchasing incentives that match the PIQ parameters. The consumer may be notified of any matches for identified purchasing incentives, and any corresponding limitations or details for the purchase. For example, the consumer may be eligible for a purchasing incentive for the desired product or service only during certain time periods, or if the product or service is purchased from specific retailers or providers. If no purchasing incentives are identified, the consumer may be notified of this result as well.

PIQs, as well as some or all of the marketing data of the consumers, may be made available to the registered offering companies and organizations. This information may be provided anonymously, and may be provided either to just those registered offering companies and organizations that offer the querying consumer a purchasing incentive for a particular PIQ, or alternatively may be provided to all registered offering companies and organizations.

In other embodiments, the consumer may register with the PIQ Management System and receive a registration number/name and/or password. However, information concerning consumer membership in loyalty programs may be input along with PIQ parameters for each individual query as opposed to submitting loyalty program membership information to the PIQ Management System for storage. In other embodiments, loyalty program membership information may be stored on the consumer's system in software designed to operate with the PIQ Management System, and the information may be provided to the PIQ Management System during each session. In yet other embodiments, the PIQ Management System may only provide a text readout of the incentives available under an identified loyalty program for the consumer to examine, wherein the consumer may determine whether a purchasing incentive is available for the desired product or service.

In certain embodiments, the PIQ Management System may submit the PIQs directly to the registered offering companies and organizations, rather than storing the rules and conditions of the loyalty programs of each registered offering company and organization in a database. Those registered offering companies and organizations can determine whether they offer purchasing incentives in response to the PIQ, and can so notify the PIQ Management System which then notifies the querying consumer. Alternatively, the registered offering company and organization may notify the querying consumer directly if a purchasing incentive is available, along with details and restrictions on use of the purchasing incentive.

In certain embodiments, the PIQ Management System may offer consumers promotion compensation (“PC”) offers if no purchasing incentive is identified in accordance with the PIQ. Alternatively, the PIQ Management System may offer consumers a PC in addition to any available purchasing incentives for simply using the PIQ Management System. PCs may consist of any type of offer, including discount coupons on certain products or services to cash to credits to be used in the PIQ Management System on future queries to any other award effective to motivate a consumer to use the PIQ Management System in the future.

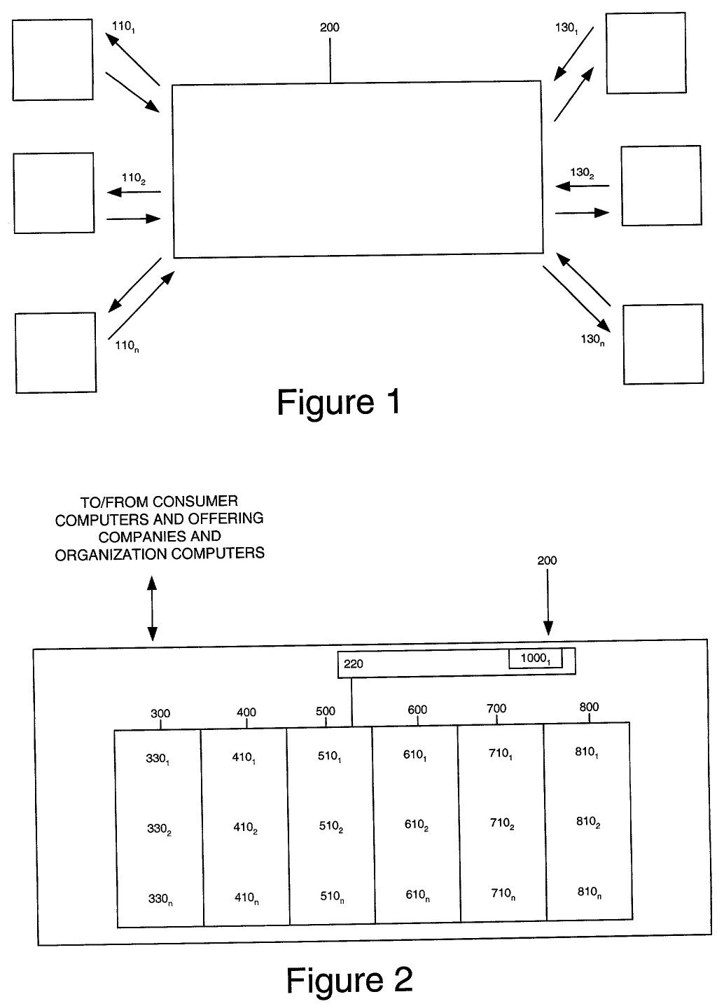

Referring to FIG. 1, an embodiment of the PIQ Management System 200 is displayed. The PIQ Management System 200 may be a central computer accessible by a plurality of consumer computers 110₁ through ll0ₙ and a plurality of offering companies and organizations computers 130₁ through 130ₙ The PIQ Management System 200 may communicate with the plurality of consumer computers 110₁ through 110ₙ and offering companies and organizations computers 130₁ through 130ₙ over the Internet, or via an Intranet, LAN, WAN, or any other wired or wireless connection now known or later developed.

In FIG. 2, the PIQ Management System 200, shown in greater detail, may comprise various processors and interactive databases. In one embodiment, processor 220 may interface with consumer computers 110₁ through 110ₙ and offering companies and organizations computers 130₁ through 130ₙ, and may be capable of receiving information from and transmitting information to consumer computers 110₁ through 110ₙ and offering companies and organizations computers 130₁ through 130ₙ. Processor 220 may include a web server capable of communicating with consumer computers 110₁ through 110ₙ and the offering companies and organizations computers 130₁ through 130ₙ via secure protocols such as SSL and https. PIQ Management System processor 220 may also comprise a Rules and Conditions subroutine 1000, which may be capable of programmed response to evaluate PIQs, rules and conditions of loyalty programs of offering companies and organizations, and PC offer conditions. Processor 220 may be capable of interacting with various databases also found in PIQ Management System 200.

PIQ Management System 200 may also comprise interactive searchable databases 300, 400, 500, 600, 700, and 800. Interactive searchable database 300 may store information relating to offering companies and organizations 130₁ through 130ₙ in files 330₁ through 330ₙ. Interactive searchable database 400 may store information relating to consumers 110₁ through 110ₙ in files 410₁ through 410ₙ. Interactive searchable database 500 may store information relating to PIQs in files 510₁ through 510ₙ. Interactive searchable database 600 may store information relating to rules and conditions of loyalty programs in files 610₁ through 610ₙ. Interactive searchable database 700 may store information relating to PC offers in files 710₁ through 710ₙ. Interactive searchable database 800 may store information relating to results of PIQ searches in files 810₁ through 810ₙ.

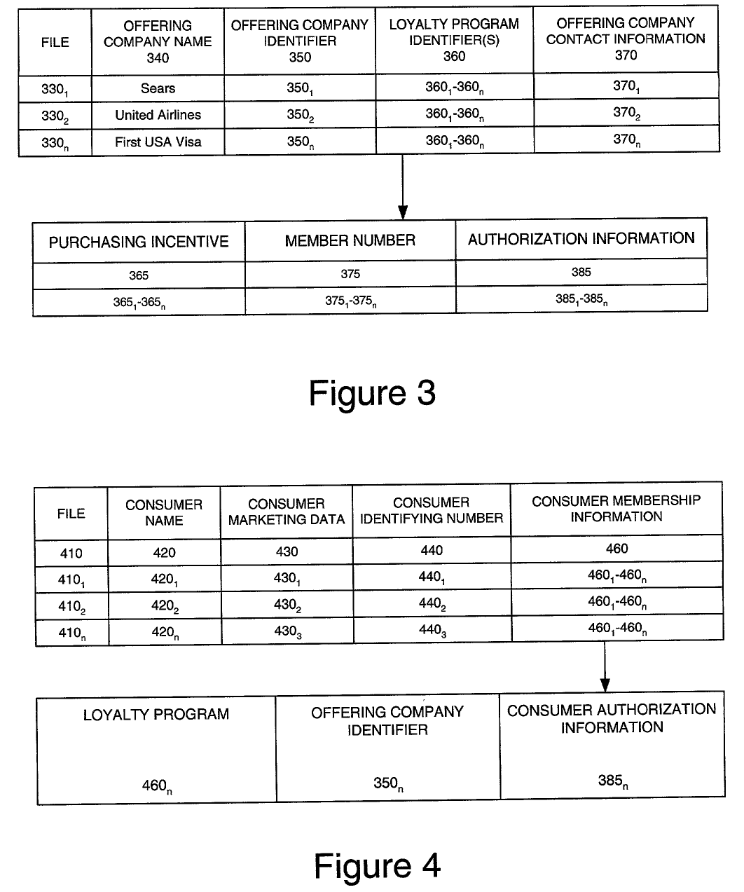

FIG. 3 shows further details of an embodiment of interactive searchable database 300. Information relating to offering companies and organizations 130₁ through 130ₙ may be stored in files 330₁ through 330ₙ of interactive searchable database 300. Stored information may relate to offering company or organization name 340, offering company or organization identifier number 350 (which may be assigned by the PIQ Management System), offering company or organization loyalty programs 360, and offering company or organization contact information 370. An offering company or organization may have multiple loyalty program entries which may be labeled 360₁ through 360ₙ, respectively. Each file containing information relating to an entered offering company or organization loyalty program 360ₙ may be further divided into searchable interactive subfiles which store information relating to loyalty program 360ₙ as available purchasing incentives 365₁, through 365ₙ, loyalty program member 375₁ through 375ₙ and authorization information 385₁ through 385ₙ as PIN or password or account identification for each member 375₁ through 375ₙ. Finally, interactive searchable database 300 may store offering company or organization contact information in searchable interactive files 370₁ through 370ₙ.

FIG. 4 shows further details of an embodiment of interactive searchable database 400. Information relating to consumers 110₁ through 110ₙ may be stored in files 410₁ through 410ₙ of interactive searchable database 400. Stored information may relate to consumer name 420, consumer marketing data 430, consumer address 440, consumer identifying number 450, and loyalty program memberships 460₁ through 460ₙ for each consumer 110₁ through 110ₙ. Each file containing information relating to an entered loyalty program membership 460ₙ may be further divided into subfiles which store information relating to loyalty program membership as offering company or organization identifier number 350₁ through 350ₙ., and consumer authorization information 385₁ through 385ₙ as PIN or password or account number. Note that in alternative embodiments, information relating to each consumer's loyalty program memberships may not be stored in the PIQ Management System but instead may be entered upon the submission of each PIQ or may be stored on the consumer's system such that it may be automatically retrieved by the PIQ Management System central processor 220.

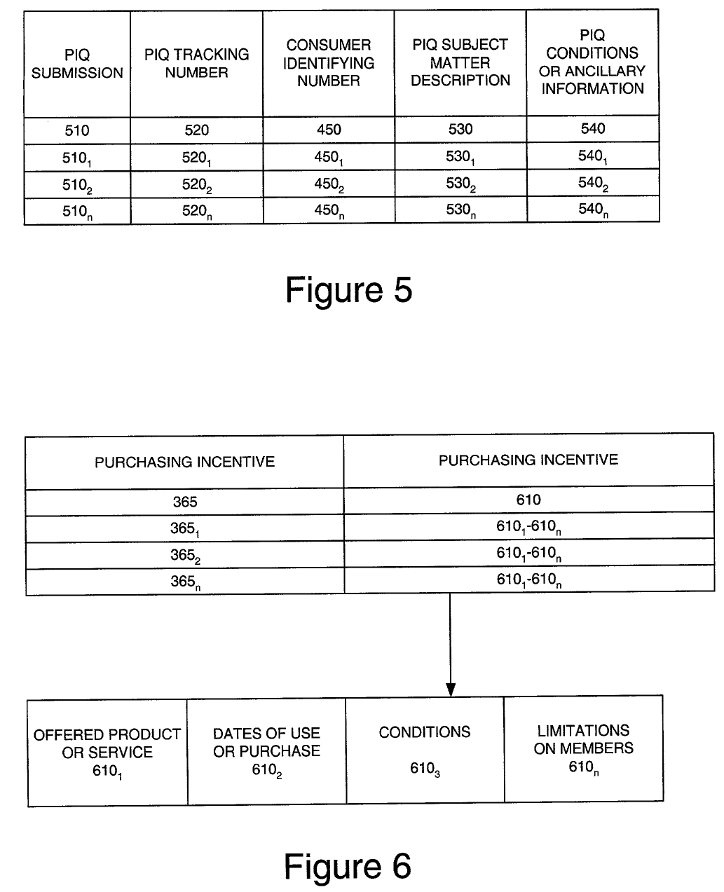

FIG. 5 shows further details of an embodiment of interactive searchable database 500. Information relating to PIQ submissions may be stored in files 510₁ through 510ₙ of interactive searchable database 500. Stored information may relate to assigned PIQ tracking number 520, submitting consumer identifying number 450, PIQ subject matter description 530, and, if applicable, dates of use of requested product or service or other PIQ ancillary information 540.

In FIG. 6, further details of an embodiment of interactive searchable database 600 are provided. Information relating to rules and conditions of each loyalty program purchasing incentive 365₁ through 365ₙ of the loyalty programs 360₁ through 360ₙ of offering companies and organizations 130₁ through 130ₙ may be stored in files 610₁ through 610ₙ of interactive searchable database 600. Each loyalty program purchasing incentive program rules and conditions file 610₁ through 610ₙ may contain rules and conditions including offered product and service description 610₁, dates available 610₂, and limitations on use of purchasing incentives 610₃. Interactive searchable database 600 may also have rules and conditions 610ₙ that limit certain purchasing incentives to certain loyalty program members 375_{n.}

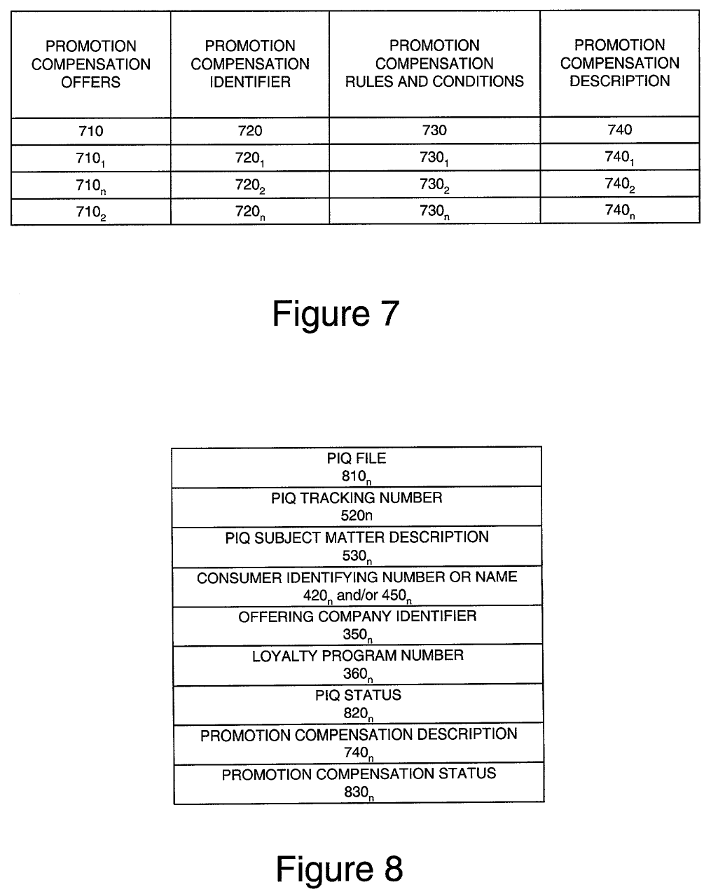

In FIG. 7, further detail of an embodiment of PC interactive searchable database 700 is provided. Information relating to PC offers may be stored in files 710₁ through 710ₙ in interactive searchable database 700. Each PC offer file 710₁ through 710ₙ may contain information relating to PC offers as promotion compensation identifier number 720, rules and conditions 730₁ through 730ₙ, and description 740. The rules and conditions files 730₁ through 730ₙ may contain subfiles setting forth each rule and condition for a consumer to qualify for that PC offer.

FIG. 8 provides further detail of interactive searchable database 800. Information relating to PIQ history may be stored in files 810₁ through 810ₙ of interactive searchable database 800. In a sample file 810ₙ, stored information may include PIQ tracking number 520ₙ, PIQ subject matter description 530ₙ, consumer identifying number or name 420ₙ and/or 450ₙ, offering company or organization identifier number 350ₙ, offering company or organization loyalty program identifying number 360ₙ., status of PIQ 820ₙ, offered PC description 740ₙ, and status of PC 830ₙ.

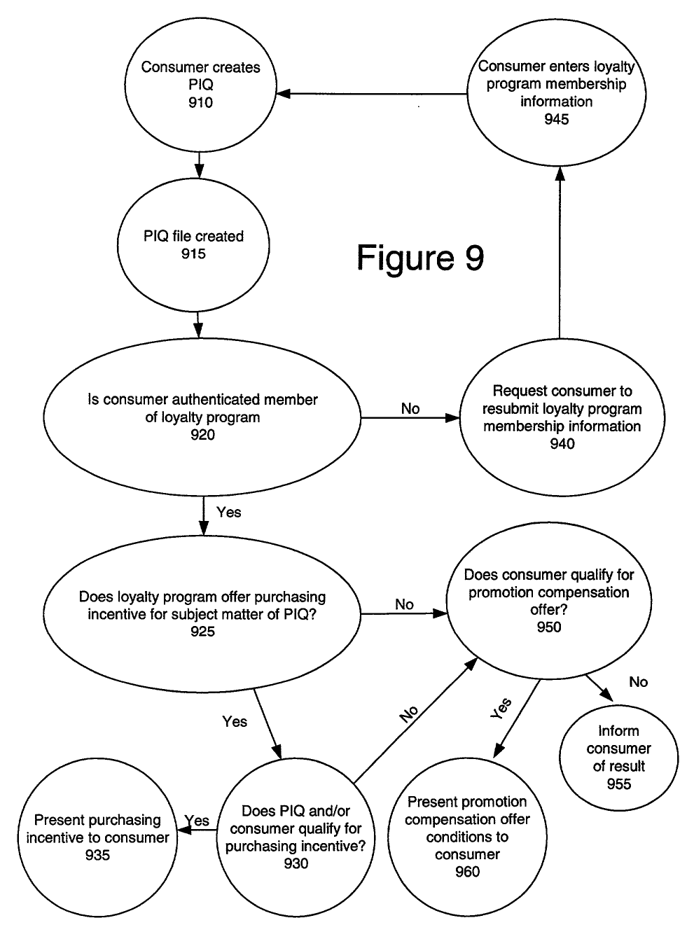

FIG. 9 displays a processing flowscheme of a PIQ according to one embodiment of the invention. At 910, a consumer registered to use the PIQ Management System 200 contacts the PIQ Management System and enters information relating to a PIQ such as product or service description and dates of use or purchase. A PIQ 510ₙ is created at 915 in the PIQ Management System. At 920, the PIQ Management System main processor 220 searches the offering companies and organizations interactive searchable database 300 to identify files corresponding to the loyalty programs 460₁ through 460ₙ entered by the consumer 450ₙ along with accompanying consumer authentication information for that loyalty program 385ₙ. At this step, the PIQ Management System may authenticate that the querying consumer 450ₙ is enrolled in the designated loyalty programs 460₁ through 460ₙ, according to the enrollment information provided by the offering companies and organizations. If the querying consumer 450ₙ is not authenticated, at 940 the consumer may be prompted by the PIQ Management System to resubmit loyalty program membership information, which the consumer may enter at 945 to restart the process at 910.

If the querying consumer 450ₙ is authenticated, at 925 the PIQ Management System may then determine whether the offering companies or organizations offer a purchasing incentive 365ₙ that may apply to the product or service that is the subject matter 530ₙ of the submitted PIQ 510ₙ. If a purchasing incentive 365ₙ is available, the PIQ Management System may determine if the consumer 450ₙ and the PIQ 510ₙ qualify for the purchasing incentive at 930. If the answer is yes, details of the qualifying purchasing incentive 365ₙ may be passed on to the querying consumer at 935.

If the consumer or the PIQ does not qualify for a purchasing incentive, or if the offering company or organization does not offer a purchasing incentive in response to the PIQ, the querying consumer may be considered for a PC offer. The PIQ Management System may determine whether a PC offer 710ₙ is available for the querying consumer at 950. If the answer is yes, the consumer may be offered a PC 710ₙ and may be informed of any conditions 730ₙ for that PC offer at 960; if the answer is no, at 955 the consumer is notified that there is no purchasing incentive or promotion compensation offer available. In other embodiments, the consumer may be considered for a promotion compensation even if the PIQ qualifies for a purchasing incentive.

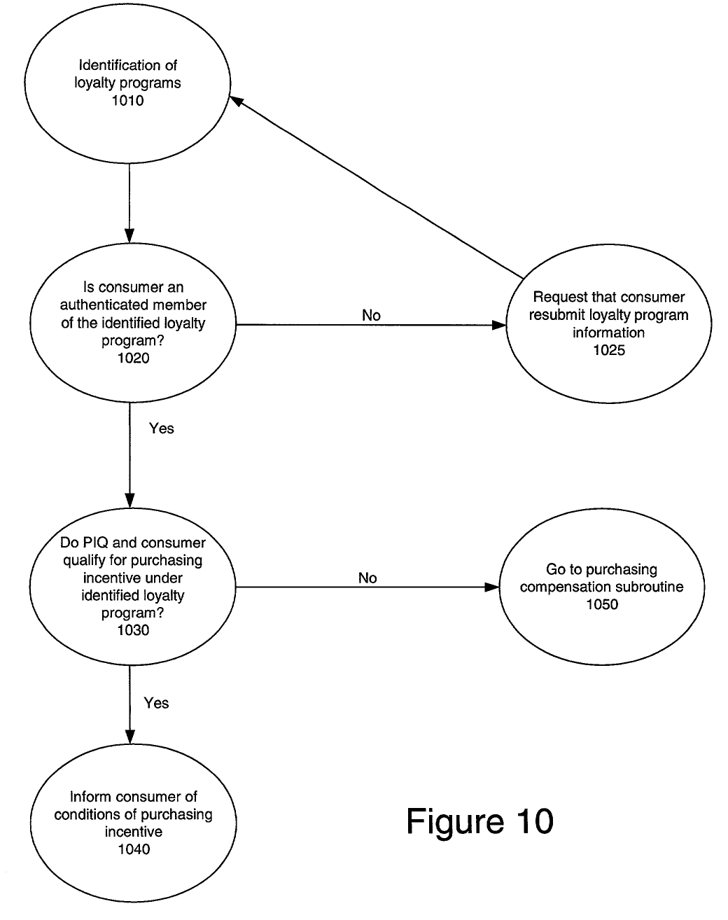

FIG. 10 displays a processing flowscheme for the rules and conditions 610₁ through 610ₙ of a loyalty program 460ₙ of an offering company or organization in one embodiment of the invention. When a registered consumer 450ₙ submits a PIQ 510ₙ, the PIQ Management System may determine which loyalty programs 460₁ through 460ₙ that the querying consumer is a member from the querying consumer's files at 1010. At 1020, the PIQ Management System may search interactive searchable database 300 and authenticate that the querying consumer 450ₙ is a member of the identified loyalty programs 460₁ through 460ₙ. If the querying consumer 450ₙ cannot be authenticated, the PIQ Management System may prompt the consumer at 1025 to resubmit loyalty program information, and start the process over at 1010.

If the querying consumer 450ₙ is authenticated, the PIQ 510ₙ may be submitted to the rules and conditions processing subroutine 1000 to determine whether the PIQ 510ₙ and the consumer 450ₙ qualify for a purchasing incentive at 1030. If the PIQ 510ₙ so qualifies, the querying consumer 450ₙ is notified either by the PIQ Management System or the offering companies and organizations sponsoring the qualified loyalty programs 460₁ through 460ₙ of the details of the available purchasing incentives 365₁ through 365ₙ at 1040. If the consumer 450ₙ is not authenticated or the PIQ 510ₙ does not qualify, the consumer 450ₙ may be considered for a PC offer 710ₙ at 1050.

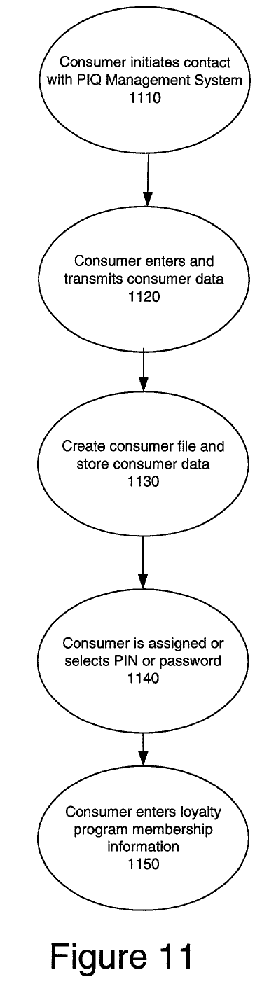

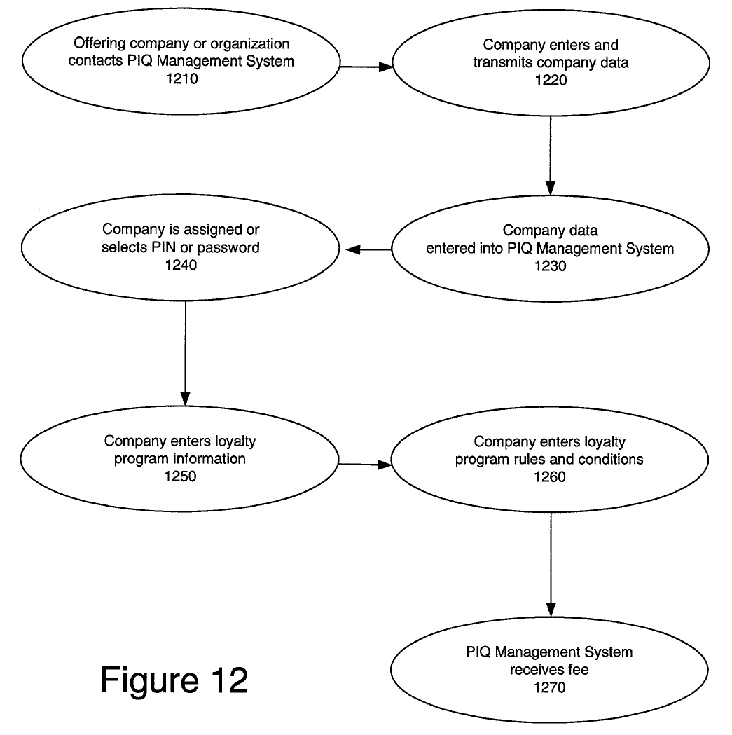

Enrollment of the consumer and the offering company or organization is shown in FIGS. 11 and 12. At 1110 in FIG. 11, the consumer may initiate contact with the PIQ Management System and enters and transmits personal and marketing data at 1120, which may be stored in a file addressed by the consumer identifying number at 1130. The consumer may either select or be assigned a PIN or password at 1140 which is stored to be used for future access to the PIQ Management System, where the consumer may be required to enter the PIN or password to be authenticated according to known or later developed authentication techniques. The PIQ Management System may prompt the enrolled consumer to enter information relating to membership in loyalty programs at 1150, which is stored in the consumer's file. Note that the loyalty program enrollment information may be entered either at enrollment or at a later date, and may also be edited or deleted at a later date.

Similarly, as shown in FIG. 12, an offering company or organization may initiate contact with the PIQ Management System at 1210 and enter and transmit identifying information at 1220, which is stored in the PIQ Management System in a file associated with the offering company or organization file at 1230. The offering company or organization may either be assigned or may select a PIN or password which is stored to be used for future access to the PIQ Management System at 1240, where the offering company or organization may be required to enter the PIN or password to be authenticated according to known or later developed authentication techniques. The offering company or organization may enter information relating to its offered loyalty programs at 1250, and also enters rules and conditions for each offered loyalty program at 1260. The PIQ Management System may require the enrolling offering company or organization to pay a fee at 1270, or fees may be charged according to usage.

The invention is further illustrated by the following Examples which should not be regarded as limiting.

### EXAMPLE 1

A consumer may contact the PIQ Management System server through the Internet via a web browser residing on his or her computer. The PIQ Management System website may offer the consumer options to enroll as either a consumer or an offering company or organization, and options to use the system and create a PIQ. The consumer may select to enroll in the system, at which time a secure SSL session can be initiated between the PIQ Management System server and the consumer's web browser. The consumer may enter personal information as name, address, telephone number, and email address. Marketing information as demographics, income, profession, and hobbies may be entered upon prompting by the PIQ Management System. The entered information may be stored in a file that may be created for the consumer, which may be indexed by a consumer identifying number assigned by the PIQ Management System. The consumer then may be prompted to select a user name, which is checked to determine that it is unique within the PIQ Management System, and also may select a PIN or password that must be used to access the PIQ Management System in the future. The consumer may be prompted to enter information on his or her membership in various loyalty programs. The consumer may enter such information as name of the offering company or organization, account or other identifying number for the offering company or organization, and any other authorization information that may be required by the offering company or organization to access the purchasing incentives in the loyalty program. Upon completion, the consumer may log off and end the secure SSL session.

### EXAMPLE 2

An offering company may contact the PIQ Management System server through the Internet via a web browser residing on one of the company's computers. The PIQ Management System website may offer options to enroll as either a consumer or an offering company or organization, and to use the system and create a PIQ. The offering company may select to enroll in the system, at which time a secure SSL session may be initiated between the PIQ Management System server and the offering company's web browser. The offering company may enter information as name, address, telephone number, and email address. The entered information may be stored in a file that may be created for the offering company, which can be indexed by an identifying number assigned by the PIQ Management System. The offering company then may be prompted to select a user name, which is checked to determine that it is unique within the PIQ Management System, and also may select a PIN or password that must be used to access the PIQ Management System. The offering company may be prompted to enter information on offered loyalty programs, including membership lists and authorization information for each member. The offering company may also enter available purchasing incentives and corresponding rules and conditions for each loyalty program. The offering company may be charged a fee to enroll in the PIQ Management System.

### EXAMPLE 3

A consumer may contact the PIQ Management System via the Internet via a web browser residing on his or her computer, and select the option offered on the PIQ Management System web site to create a PIQ. A secure SSL session may be created between the consumer's web browser and the PIQ Management System server, and the consumer may be prompted to enter his or her user name and PIN or password. Once the consumer can be authenticated by the user name and PIN or password as an enrolled user of the PIQ Management System, the consumer may be offered several options including updating loyalty program information, updating marketing or personal data, or creating a PIQ. The consumer may select the option to create a PIQ, and may be prompted to describe the desired product or service that the consumer wishes to purchase, perhaps from a drop down list of product and service categories. The consumer may select electronics, whereupon he or she may further select a DVD player from subsequent offered drop down lists. The PIQ Management System can then authenticate that the consumer is a member of the loyalty programs he or she designated, and then may determine whether any purchasing incentives for DVD players or more generalized purchasing incentives that could be used to purchase a DVD player are available under those loyalty programs, using the rules and conditions subroutine. Any conditions on the purchasing incentive, as model or manufacturer or seller, can be provided to the consumer through the PIQ Management System. The consumer can receive a complete list of all qualified purchasing incentives for the DVD player, along with conditions, and then can use the information to maximize benefits under loyalty programs. Further, the PIQ Management System may offer the consumer links to web sites where the consumer can purchase the desired product or service, or alternatively may offer the consumer a list of contact information for the consumer to contact a vendor that offers the desired product or service.

### EXAMPLE 4

An offering company previously enrolled with the PIQ Management System may initiate contact with the PIQ Management System, log in to its account, and select an option to view marketing data on consumers that have submitted PIQs during the past six months. The PIQ Management System may have compiled the marketing data only for those consumers that submitted PIQs to that offering company, or may have compiled marketing data for all consumers that submitted PIQs to the PIQ Management System for the designated time period. The PIQ Management System may also have identified what products or services have been the subject of the PIQs. These data can be provided anonymously.

It is to be understood that the embodiments and variations shown and described herein are merely illustrative of the principles of this invention and that various modifications may be implemented by those skilled in the art without departing from the scope and spirit of the invention.

I claim:

1. A method for managing purchasing incentives offered to consumers through their memberships in loyalty programs of offering companies and organizations, the method comprising:
receiving information on membership in loyalty programs of offering companies and organizations from a plurality of consumers;
receiving a query from at least one consumer for available purchasing incentives for a product or service;
processing the query; and
transmitting information relating to the availability of purchasing incentives in response to the query of the consumer.

2. The method of claim 1, further comprising:
receiving information on membership in loyalty programs from a plurality of offering companies and organizations.

3. The method of claim 1, further comprising:
storing received information on membership in loyalty programs of offering companies and organizations from a plurality of consumers in a searchable database.

4. The method of clam 2, further comprising:
storing received information on membership in loyalty programs from offering companies and organizations in a searchable database.

5. The method of claim 1, wherein processing the query comprises transmitting the query to a plurality of offering companies and organizations and receiving information relating to the availability of purchasing incentives in response to the query.

6. The method of claim 1, wherein processing the query comprises retrieving relevant data.

7. The method of claim 1, further comprising:
storing the query in a searchable database.

8. The method of claim 1, further comprising:
storing information relating to the availability of purchasing incentives in response to the query to the consumer in a searchable database.

9. The method of claim 1, further comprising:
receiving marketing information from the consumer.

10. The method of claim 9, further comprising:
storing received marketing information in a searchable database.

11. The method of claim 9, further comprising:
transmitting at least some of the received marketing information to at least some of the offering companies and organizations.

12. The method of claim 9, wherein at least some of the received marketing information is transmitted anonymously to at least some of the offering companies and organizations.

13. The method of claim 1, wherein the consumer is offered with promotion compensation if no purchasing incentives are available in response to the query.

14. The method of claim 1, wherein a fee is received from the offering companies and organizations.

15. The method of claim 1, further comprising providing the querying consumer information relating to the purchase of the product or service that is the subject of the query.

16. A system for processing purchasing incentive queries for purchasing incentives available to consumers through their membership in loyalty programs, the system comprising:
at least one interface unit capable of receiving information from a consumer relating to the consumer's membership in at least one offering company's or organization's loyalty program, a query from the consumer requesting available purchasing incentives for a product or service, and consumer marketing data; and
at least one data processor operatively connected to the at least one interface unit which is capable of processing the query;
wherein the at least one interface unit is capable of communicating to the consumer the availability of any purchasing incentives that are offered through at least one of the consumer's membership in at least one loyalty program.

17. The system of claim 16, further comprising:
at least one interactive database operatively connected to the at least one interface unit which is capable of storing at least some information received from the consumer and being searched to retrieve at least some information received from the consumer.

18. The system of claim 16, wherein the at least one interface unit is capable of transmitting the query to at least one offering company or organization in whose loyalty program the consumer is a member and receiving a response from at least one of the offering companies or organizations relating to the availability of any purchasing incentives in response to the consumer query.

19. The system of claim 16, wherein the at least one interface unit is capable of receiving information from a plurality of offering companies and organizations relating to membership in their loyalty programs and purchasing incentives available to members of their loyalty programs; and wherein the at least one interactive database is capable of storing at least some information received from the plurality of offering companies and organizations and being searched to retrieve at least some information received from the plurality of offering companies and organizations.

20. The system of claim 19, wherein processing the query further comprises determining whether one or more purchasing incentives are available for the purchase of a product or service in response to the consumer query in response to at least some of the received information from the plurality of offering companies and organizations relating to membership in their loyalty programs and at least some of the information relating to purchasing incentives available to members of their loyalty programs.

21. The system of claim 16, wherein at least one data processor is configured to compensate the consumer with an offer of promotion compensation upon the satisfaction of at least one condition.

22. A method for determining if purchasing incentives are available to a consumer through the consumer's membership in at least one loyalty program of at least one offering company or organization, the method comprising:
receiving a purchasing incentive query from a consumer;
processing the purchasing incentive query to determine if at least one purchasing incentive is available through the consumer's membership in at least one loyalty program of at least one offering company or organization in response to the query; and
communicating information relating to the availability of a purchasing incentive in response to the query.

23. A method for determining if purchasing incentives are available to a consumer through the consumer's membership in at least one loyalty program of at least one offering company or organization, the method comprising:
receiving information from at least one consumer relating to at least one membership in at least one loyalty program of an offering company or organization;
receiving information from at least one offering company or organization relating to at least one loyalty program offered to certain consumers;
receiving a purchasing incentive query from a consumer;
authenticating that the consumer is a member in at least one loyalty program; and
communicating information relating to the availability of all purchasing incentives for at least one loyalty programs in which the consumer is authenticated.
